(19) United States
(12) Patent Application Publication
(10) Pub. No.: US 2013/0159011 A1
(43) Pub. Date: Jun. 20, 2013

(54) PROVIDING HEALTH-CONDITION SPECIFIC COACHING IN A SOCIAL NETWORK

(71) Applicant: Kevin LEVILLE, New Canaan, CT (US)

(72) Inventor: Kevin LEVILLE, New Canaan, CT (US)

(21) Appl. No.: 13/689,142

(22) Filed: Nov. 29, 2012

Related U.S. Application Data
(60) Provisional application No. 61/565,331, filed on Nov. 30, 2011.

(51) Int. Cl. G06Q 50/22; G06Q 50/00

(52) U.S. Cl. CPC G06Q 50/22; G06Q 50/01
USPC 705/2

(57) ABSTRACT

The present invention is in the field of social networking, and in particular to systems and methods for linking users together that have common health conditions, or an interest in such health conditions, to coach users by providing information on such conditions. Such information includes health condition-specific information, which necessarily includes health condition-specific nutritional information.

### CROSS-REFERENCE TO RELATED APPLICATIONS

This application is a continuation of U.S. Provisional Patent Application No. 61/565,331 entitled “Providing Health-Condition Specific Coaching in a Social Network” and filed Nov. 30, 2011, the contents of which are incorporated herein in their entirety.

### TECHNICAL FIELD

The present invention is in the field of social networking, and in particular relates to systems and methods for linking users together that have common health conditions, or an interest in such health conditions, to coach users by providing information on such conditions. Such information includes health condition-specific information, which necessarily includes health condition-specific nutritional information.

### BACKGROUND OF THE INVENTION

Computer-implemented social networking has evolved as a new forum for people to meet one another and to share ideas, experiences and information. Whereas people used to belong to special interest groups and attend meetings, social events and other gatherings such as parties, etc., today's world allows people from diverse backgrounds and geographic locations to “socialize” over the computer without the inconvenience of travelling.

Social networks now exist to link people to one another for purposes of dating, sharing interests, keeping families connected in different locations, and for many other purposes simply to facilitate communications for given purposes. Most networks allow users to choose which individuals they want to network with and what information they desire to share with their network. There even exists an international publication devoted to social networks (Elseveir, B.V.), which is in fact a social network for individuals interested in social networks.

Stated simply, a “social network” is a collection of people and their relationship to one another. This relationship may be a common workplace, a common ethnic or religious group, or even owners of a common breed of dog.

Social networks can provide motivation to individuals seeking to change personal behavior. See, for example, U.S. Pat. No. 7,720,855, which discloses behavior modification through the accountability of the user to the user's “allies” within the network. However, this type of behavior modification requires the user to reveal personal information about their progress towards behavioral change to their friends, which many would consider to be an undesirable disclosure of personal information. For example, if the user is seeking to change their eating habits to lose weight, in order for the system to work, they would have to reveal their weight and food consumption to their friends on an ongoing basis.

The present invention relates to a social network for providing health condition-specific coaching, including nutritional-specific dietary recommendations, as well as other information, to users having a common health condition or an interest in the common condition.

### SUMMARY OF THE INVENTION

The computer-implemented method of the present invention is designed to manage health condition-specific information about users and their relationships in a social network. In one embodiment, it includes the steps of: obtaining information from the users by the computer relating to a health condition; maintaining in a computer system a plurality of relationships between users with common health conditions in a social network, each relationship comprising a commonality between at least two users of the social network, wherein the relationship further comprises a virtual table of users; generating health condition-specific information by the computer to share with the virtual table, wherein the health condition-specific information further comprises health condition-specific nutritional information; allowing for input and exchange of user-specific information among the users sitting at the virtual table via the computer system at the discretion of the user; and displaying the user-specific information and health condition-specific information to the users of the virtual table.

In addition to the above, individual users may become “allies” within the network.

In one embodiment, the health condition-specific nutritional information may include information about groupings of foodstuffs to be consumed by individuals with the health condition. Such groupings may include, for example, cooked green vegetables, raw green vegetables, non-green vegetables, fruit, beans, and nuts and seeds. It may also include a recommended portion size and/or consumption frequency (daily/weekly) for each grouping of the foodstuff.

It should also be pointed out that the information from the users relating to the health condition may include identifying a user as an individual with the health condition, or identifying the user as an individual who knows someone else with the health condition or simply has an interest in learning more about the health condition.

Other aspects of the invention are found throughout the specification.

### DRAWINGS

FIG. 1 is a flow diagram of an exemplary embodiment of the method of the present invention.

### DETAILED DESCRIPTION OF THE INVENTION

The present invention provides systems and methods for linking users together that have common health conditions, or an interest in such health conditions, and for coaching users by providing information on such conditions. It does so by allowing users to “sit” at virtual “tables” with other users having a common interest in the same health condition. As such, it is a virtual Café for users to visit, sit where they want, have access to information on the health condition, including health condition-specific nutritional information, and share this information as well as personal information with one another.

In the description that follows, a number of terms from the social networking field are extensively utilized. In order to provide a clear and consistent understanding of the specification and claims, including the scope to be given such terms, the following non-limiting definitions are provided.

When the terms “one,” “a,” or “an” are used in this disclosure, they mean “at least one” or “one or more,” unless otherwise indicated.

The term “table” is defined as a computer-implemented grouping of users based on the commonality of answers to the user's questionnaire regarding a health condition.

The term “health condition-specific nutritional information” is defined as information about foodstuffs and their relationship, when consumed, to the health condition or conditions. It may include information that the food is good, bad, or has no affect on the health condition(s), as well as information regarding portion size, recommended portions per meal/day/week, etc.

The term “activity stream” is defined as a list of the website activities of a specific single entity such as a user, table or forum, or a collection of these entities in the case of a user's activity stream, which includes the activity of all of their identified and associated allies, tables and forums.

The term “ally” is defined as a relationship between two or more users of the network, wherein allies are permitted more direct access to the user's profile and personal information, such as their photos, a blog, etc.

The term “coaching” is defined as providing information and providing an opportunity for users to exchange information relating to a particular health condition.

The term “manage health condition-specific information about users and their relationships in a social network” is used to refer to the fact that the network facilitates the flow of health condition-specific information from the network to the users, and between individual users and groups of users.

### User Interface and Initial Setup

The social network user signs up to use the network with a prearranged login and password, or creates a login and password when prompted, and is then requested to enter personal information and complete a questionnaire regarding the health condition or conditions they have an interest in. In one embodiment, the questionnaire can be used to predict a likelihood that a person has or will have a health condition or conditions based on the input. All user input is at the discretion of the user, and is not required to be provided to participate in the network. However, in one embodiment of the invention, and in order to take full advantage of the network, the user may also want to provide personal health condition-specific data, such as weight, blood pressure, etc.

In one embodiment of the present invention, the user may have ties to an individual with a health condition or conditions, such as a family member, a colleague, a friend, etc., in which case the user can indicate in the questionnaire that they do not themselves have the health condition. In another embodiment, the user may simply have an interest in learning more about the health condition.

In another embodiment of the present invention, the user may have risk factors for developing a health condition or conditions in the future, which may be known, or which may be determined by the computer based on the initial user input.

In addition to registering with the network, the user may also customize their profile by choosing themes, icons, avatars, and other symbols to help enrich the networking experience.

The network server stores the information provided by the user, including the heath condition-specific information provided by the user. Based on this information, the computer generates a list of tables the user may be interested in joining by finding a commonality between the user-provided information with that of other existing registered users, such commonality being focused on the health condition, or subsets within the health condition (such as an obese individual having a body mass index between a certain range.)

This computer-generated list of tables is then provided to the user to allow them to instantly join any or all of the computer-suggested tables, as well as others that may be of interest to them.

After joining a table, the information that the user identifies is permitted to be shared with other table member is instantly accessible by all users at the table. This exchange of information becomes part of the table's and the user's “activity streams”.

In addition to groupings by “table”, the user may participate in a “forum” consisting of any grouping of individuals within a table interested in a particular forum topic. In addition, the user may themselves post an invitation to participate in a forum based on their own suggestion of a forum topic.

Further, at the one-on-one level, the user may choose to participate in a closer relationship with one or more network users by selecting them as an “ally”, which is the same as “friending” them, as this term has become known in the relevant social media arts.

Accordingly, a user's activity stream may consist of a hierarchical exchange of information at the forum, table, and/or ally level, and this activity stream can be displayed to the user so that at any given time, the user can view the accumulated activity of their designated of forums, tables and allies.

### Health Condition-Specific Information

The present invention provides “coaching” to users at a table by providing easy access to health condition-specific information. This may include computer links to third party websites that provide further information about a health condition or conditions. Additional forms of information include, for example, links to videos, scientific articles, news articles, and other forms of content pertaining to the health condition(s).

It is important to note that this network is not intended to provide a forum of user accountability to a group of other users. It is primarily intended to provide a one way flow of computer-generated useful information to the user, although the exchange of information between users is also contemplated. However, there is no metric associated with the network to track an individual's progress towards resolution of a health condition, and indeed the user may not even have the health condition.

This health condition may be, for example, high blood pressure, high cholesterol, allergies, auto-immune disease, cancer, diabetes, heart disease, migraines, depression, osteoporosis, stroke, etc., or more than one of these conditions.

Taking diabetes as an example, health condition-specific information may include any or all of the following: links to publicly maintained websites, such as glucerna.com; links to government sponsored websites such as http://www.ncbi.nlm.nih.gov/pubmedhealth/PMH0002194/; links to organizations such as www.diabetes.org; and links to vendors of diabetes-related media. In addition to simply providing a computer link to a third party source of information, the network of the present invention provides the information itself to its users via a “click through” architecture on the website and/or the table homepage. Such architecture may be organized by type of media (videos, books, articles, etc.), each such type including subtypes, subsubtypes, etc., until the user is presented with a list of resources to which they are given direct access.

It should be well understood by someone of skill in the art that health condition-specific information can easily be compiled for virtually any health condition using numerous publicly available resources, such as the internet, libraries, medical associations, physician's groups, etc.

### Nutritional Information

A key component of the present invention is the ability to provide health condition-specific nutritional information to users, for example, in the form of individual food items and recipes that are beneficial to the health condition. This can take the form of user-directed access to “tabs” associated with the health condition that users at the table have in common, which take the user to various additional content, such as groups of foods that are beneficial or harmful for individuals suffering from the heath condition.

In one embodiment, foodstuffs may be grouped together as follows: cooked green vegetables, raw green vegetables, non-green vegetables, fruit, beans, and nuts and seeds. Within each group, foods can be ranked or scored based on their relationship to the health condition. For example, if the health condition is obesity, foods that are dense in calories may receive a low score. In any event, a necessary component of the present invention is to provide nutritional information that is pertinent to the treatment and control of the health condition.

In addition to scoring individual foodstuffs relative to the health condition, the nutritional information may also include information about recommended portion sizes, recommended number of portions per day or week, etc. The nutritional information may also include daily/weekly menu plans designed to address specific health conditions, as well as recipes that include such foodstuffs.

### Operation

In typical operation, users are connected to the network via the internet. Communication between the user and the network may be over a wireless gateway, such as a short message system, WiFi, Bluetooth, or the like. The network is accessible by any means commonly used to access a computer network, such as a personal computer, cell phone, tablet, laptop, PDA, or any other device from which wireless communication with the internet can be established. Accordingly, the network can be conveniently accessed on any portable device that is carried or worn when traveling or performing activities.

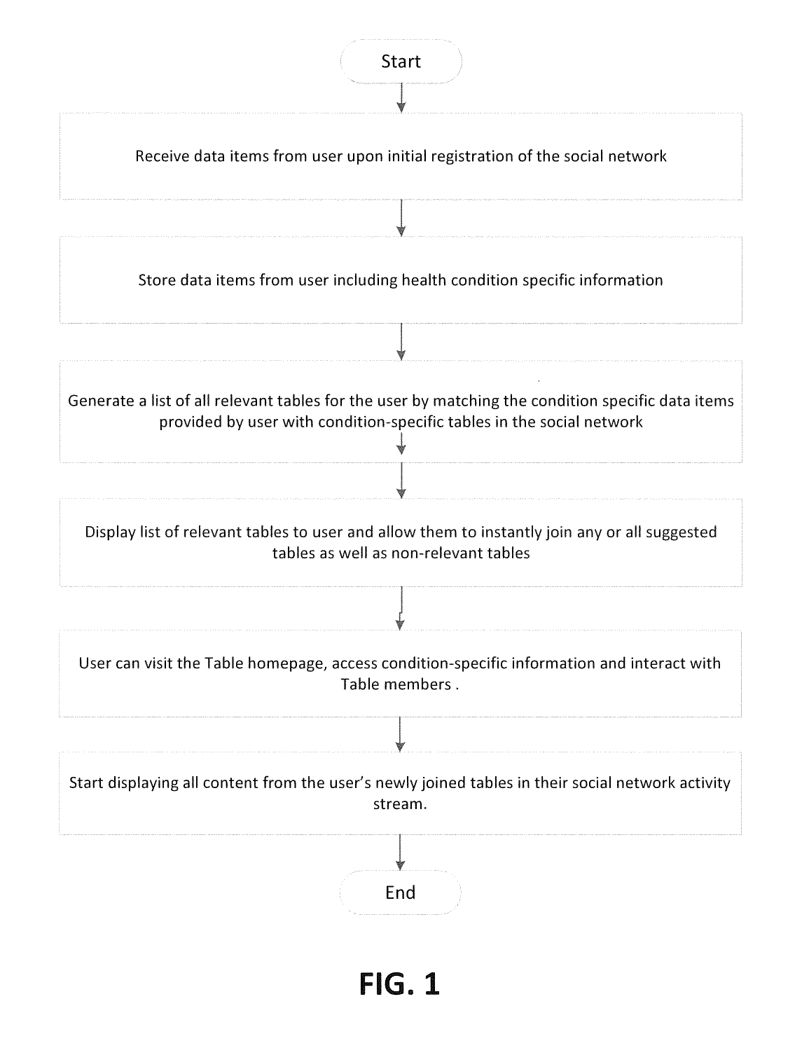

Turning now to FIG. 1, users of the social network provide information in the form of “data items” to the network upon initial registration of the social network. This usually takes the form of answering questions when prompted after joining the social network. The social network engine, which may consist of the social network website along with one or more associated servers, stores the data, including data from the user about their having, or knowing someone who has, a particular health condition.

The users may access the network via a laptop or personal computer, a smart phone, a PDA or other such device with internet access. The difference between the present invention and other more conventional social networks is that, once the users supply the health condition-specific information to the network, the network provides a list of relevant tables for the user to select to participate in. The user may override this list and join a table that is not preselected by the network, but it is to be understood that the network uses information supplied to it by the users to try and “sit” users at “tables” that are best suited to provide health condition-specific information and coaching to users based on their common characteristics.

The network may also provide a table homepage, which allows participants of the table to access health condition-specific information and to interact more directly with table members.

Once a table has been selected by the user, the content from the tables is displayed in the user's network activity stream.

The embodiments discussed above are provided to give those of ordinary skill in the art a complete disclosure and description of how to make and use the embodiments of the methods, and are not intended to limit the scope of what the inventor regards as his invention. Modifications of the above-described modes (for carrying out the invention that are obvious to persons of skill in the art) are intended to be within the scope of the following claims. All publications, patents, and patent applications cited in this specification are incorporated herein by reference as if each such publication, patent or patent application were specifically and individually indicated to be incorporated herein by reference.

I claim:

1. A computer-implemented method for managing health condition-specific information about users and their relationships in a social network, comprising:
obtaining information from the users by the computer relating to a health condition or conditions;
maintaining in a computer system a plurality of relationships between users with common health conditions in a social network, each relationship comprising a commonality between at least two users of the social network, wherein the relationship further comprises a virtual table of users;
generating health condition-specific information by the computer to share with the virtual table, wherein the health condition-specific information further comprises health condition-specific nutritional information;
allowing for input and exchange of user-specific information among the users sitting at the virtual table via the computer system at the discretion of the user; and
displaying the user-specific information and health condition-specific information to the users of the virtual table.

2. The method according to claim 1 further comprising creating allies between users within the social network.

3. The method according to claim 1, wherein the health condition-specific nutritional information further comprises information about groupings of foodstuffs to be consumed by individuals with the health condition.

4. The method according to claim 3, wherein the groupings comprise: cooked green vegetables, raw green vegetables, non-green vegetables, fruit, beans, and nuts and seeds.

5. The method according to claim 4, wherein the health condition-specific nutritional information further comprises a recommended portion size and consumption frequency for each grouping of the foodstuff.

6. The method according to claim 1, wherein the information from the users relating to the health condition further comprises identifying a user as an individual with the health condition, or identifying the user as an individual who knows someone else with the health condition.
